(19) United States
(12) Patent Application Publication
(10) Pub. No.: US 2016/0255240 A1
(43) Pub. Date: Sep. 1, 2016

(54) HALFTONING

(71) Applicant: HEWLETT-PACKARD DEVELOPMENT COMPANY L.P., Houston, TX (US)

(72) Inventors: Peter MOROVIC, Sant Cugat del Valles (ES); Jan MOROVIC, Colchester (GB)

(21) Appl. No.: 15/032,928

(22) PCT Filed: Oct. 30, 2013
(86) PCT No.: PCT/EP2013/072740

§ 371 Date: Apr. 28, 2016

(51) Int. Cl. H04N 1/405; H04N 1/52

(52) U.S. Cl. CPC H04N 1/4053; H04N 1/52

(57) ABSTRACT

An example computer-implemented method of generating a pattern of thresholds for halftone printing of an image is disclosed. The halftone pattern is generated by an analytical computation of threshold values in-situ using a quasicrystal function. Each halftone pattern produced is non-periodic yet possesses ordered character where the pattern does not line up perfectly with a shifted copy of itself. The generation of such halftone patterns is suited to applications where a single halftone threshold value may be used per pixel.

### BACKGROUND

Halftoning is used to print one or more halftone images on a printing system. A halftone image comprises a plurality of individual pixels wherein the spatial density of the layout of the pixels control the shading of different areas of the print. For example, a high density of pixels may appear a darker shade to an observer than a low density of pixels which may appear a lighter shade. Each halftone pixel in a printed image may relate to a droplet of printing fluid or ink released by a printing system printhead for example. The overall result of the plurality of dots in the printed image is to produce a color or monochrome image. An image to be printed may be represented by image data. A halftone pattern, mask or screen may be applied to a set of image data for obtaining a halftone image to be printed. The printed image may be comprised of a plurality of halftone dots displayed in a halftone pattern. An algorithm may be used to generate the halftone mask or pattern.

A set of image data may be broken down into smaller data sets where a halftone pattern is applied to each smaller set of image data. A halftoning algorithm results in an “intrinsic pattern” which may be applied to image content or image data. The halftoning algorithms used may be considered as “intrinsic patterns” which once applied to image data become halftoning patterns. The halftone pattern may then be repeated across many subsets of image data to obtain a fully halftoned image. Alternately, a halftone pattern may be applied to a set of image data representing a full image to be printed in order to obtain the halftoned image. Existing methods of halftoning may be accomplished using error diffusion techniques where halftoning decisions at a given pixel are made taking into account the neighboring pixels values either because halftoning error is ‘inherited’ from previously processed pixels or this error is being propagated. Hence operations are performed on spatially neighboring pixels which may influence other pixels. In the case of screen, mask or matrix halftoning the resulting halftone patterns will be periodic in nature given the fixed size of the screen/mask/matrix and its repetition. Instead error diffusion type output is inherently sequential and hard to predict due to its spatial processing.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a schematic illustration showing a printing system for producing a print output;

FIG. 2 is a schematic diagram showing an apparatus for processing image data according to an example;

FIG. 3A is an illustration showing an example image to be printed that is divided into subsets of image data corresponding to subsets of print regions;

FIG. 3B is an illustration showing the image data representing the image subsets of FIG. 3A;

FIGS. 4A-D show examples of quasicrystal halftone patterns generated using an example quasicrystal equation whilst varying the n parameter;

FIGS. 5A-D show examples of quasicrystal halftone patterns generated using an example quasicrystal equation whilst varying the t parameter;

FIG. 5E shows the effect that varying the t-parameter has on the amplitude and spatial variation throughout each quasicrystal pattern;

FIG. 6A is a flow chart that shows a method for generating a non-uniform quasicrystal pattern;

FIG. 6B is a schematic illustration showing an example (non-uniform) quasicrystal pattern;

FIG. 6C is a schematic illustration showing a histogram of the quasicrystal pattern of FIG. 6B;

FIG. 7 is a flow chart that shows a method for obtaining a uniform quasicrystal halftone pattern;

FIG. 8A is a flow chart that shows a method for generating a uniform quasicrystal pattern;

FIG. 8B is a schematic illustration showing an example uniform quasicrystal pattern which may later be applied to a subset of image data;

FIG. 8C is a schematic illustration showing a histogram of the uniform quasicrystal pattern of FIG. 8B;

FIG. 9 is a flow chart that shows a method for outputting print data for a quasicrystal halftone image;

FIG. 10A is a schematic illustration that shows an example RGB image to be printed;

FIGS. 10B-D are schematic illustrations that show example halftone images after the image data of the RGB image of FIG. 10A has been processed using different example quasicrystal halftone patterns as described herein;

FIGS. 11A and 11B show examples of periodic functions that may be used in a quasicrystal function to generate a quasicrystal pattern.

### DETAILED DESCRIPTION

In the following description, for purposes of explanation, numerous specific details are set forth in order to provide a thorough understanding of the present apparatus and method. It will be apparent, however, to one skilled in the art that the present apparatus and methods may be practiced without these specific details. Reference in the specification to “an example” or similar language means that a particular feature, structure, or characteristic described in connection with the example is included in at least that one example, but not necessarily in other examples.

Certain examples described herein relate to imaging and printing that may be controlled with intra-device software. Examples may be used with device software for inkjet and other types of printer to provide an ability to access a wide variety of halftoning patterns. The methods described are applicable to print systems wherein halftoning is employed to reproduce a print of an original image that may be represented by digital image data. A halftone pattern may be generated. The halftone pattern is applied to image data to obtain a halftone image to be printed using device software. A halftone image may be printed using one or more printing fluids or inks.

In certain print systems, it may be desired to improve and/or maintain print quality. For example, certain printing systems may use a halftone screen to convert digital image data into a halftone image. The halftone screen may be repeatedly applied to blocks of image data for reproducing an original image through the printing of a halftone image. The regularity and the tiling of screens over larger image content as well as the nature of constraints in halftone screen design may impact attributes such as detail and line-quality and may also result in artifacts such as banding. For example for a regular halftone screen and a regular perturbation in the printing system, the interaction between the two regular patterns may result in uniform banding. Also, in the case of some screens, for example so-called cluster-dot halftoning screens (highly regular and clustered patterns) [see Digital Halftoning by Robert Ulichney, MIT Press, 1987] result in poor quality for thin, low-density lines and may be suboptimal for preservation of high-frequency detail. Print artifacts are print defects which stand out in a printed image or are picked out from the rest of the image more easily by eye.

In certain examples described herein image data is processed to reduce and/or avoid print artifacts such as lining or banding. Print artifacts are reduced or avoided by applying a unique halftone pattern to the image data of an image to be printed. Certain examples use a halftone pattern that is non-periodic and do not line up perfectly with a shifted copy of itself. A printed output generated by the application of such a pattern reduces the visibility of any banding artifacts that may be generated, e.g. as viewed by a human observer. In examples of this disclosure: 1. there is no need for a mask (or screen or matrix) as such because there is the ability to compute threshold values independently; and 2. there are a huge variety of patterns with varying properties of the patterns that can be derived using quasicrystal functions.

Certain examples described herein allow for the halftone pattern to be generated in situ or “on the fly” as the image data is processed or as the image is printed. This has an effect of reducing the amount of memory needed to print an image. Generating a halftone pattern or mask in situ reduces the need for predetermined threshold matrices to be stored and retrieved.

An algorithm may be used to generate a halftone pattern. There are traditionally generally two classes of algorithms that may be used for halftoning. The first class use matrices of some kind, whereas the second class use error diffusion techniques. The error diffusion algorithms are non-periodic by nature; whilst the matrix based algorithms are periodic by design. Examples of this disclosure use algorithms based neither on matrix algorithms nor error diffused techniques. Instead, a halftone pattern is produced based on a special set of functions described as quasicrystal functions, i.e. without a predetermined mask matrix and without error diffusion. The halftone patterns produced using this disclosure vary spatially, have a representative range of values over small spatial regions but are non-periodic. A halftone pattern generated for each color to be printed may or may not be the same for each color. An image may be monochrome or color. Methods for halftoning are disclosed by means of an analytical computation of threshold values. The resulting halftone patterns and printed images have visually pleasing properties. The halftoning patterns may be ordered but non-periodic, i.e. the patterns have regularity but vary spatially.

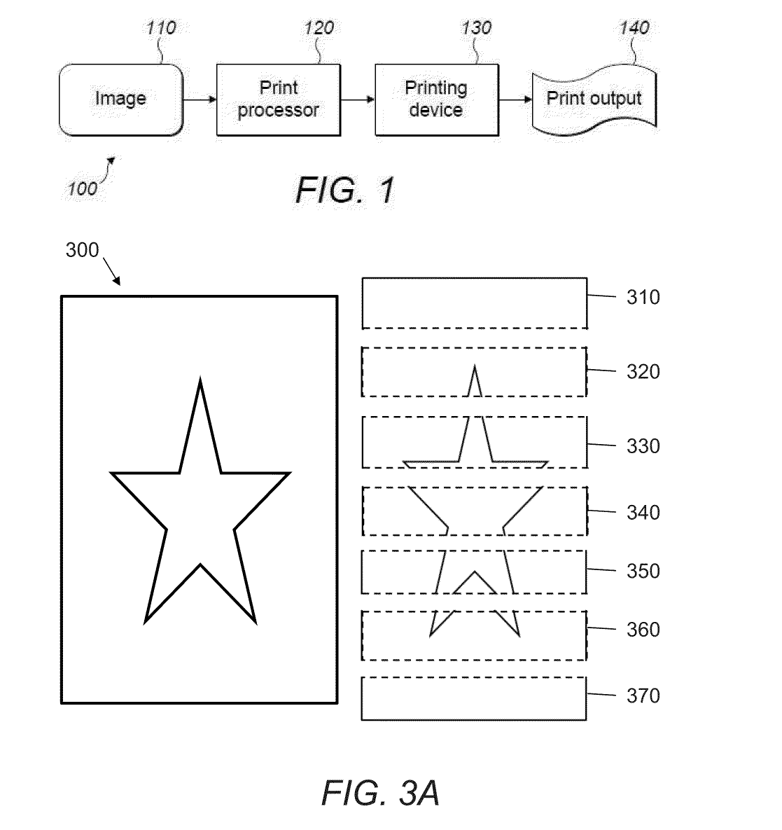

FIG. 1 shows a printing system 100 that may be used with the methods described below. The printing system 100 may be used to produce a print output. The print output comprises printing fluids or inks deposited on a print medium. There may be one or more printing fluids or inks available, for example, a monochrome print output may comprise one ink and a color print output may comprise a plurality of colored inks including black ink, for example CMYK inks. In the example of FIG. 1, image data corresponding to an image 110 is sent to a print processor 120. The print processor 120 processes the image data. It then outputs print control data that is communicated to a printing device 130. The printing device 130 generates a print output 140 as instructed by the print control data.

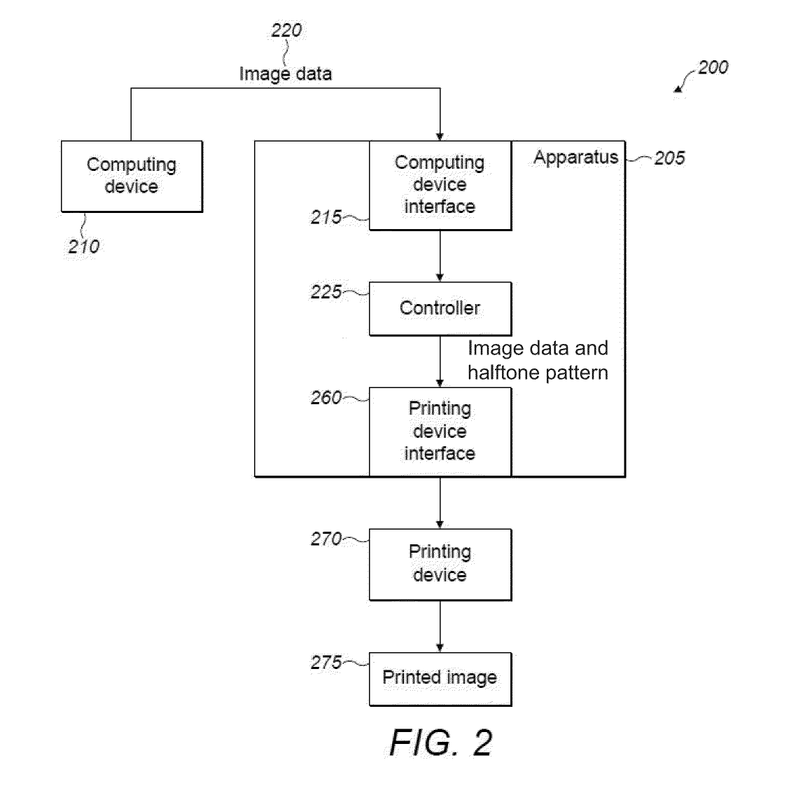

FIG. 2 shows a portion of a printing system 200 according to an example. In FIG. 2, the printing system 200 comprises apparatus 205. The apparatus 205 comprises a computing device interface 215, a controller 225 and a printing device interface 260. The apparatus 205 receives image data 220 for use in an image processing operation via the computing device interface 215. The image data 220 represents an image to be processed. For example, the image data may be digital data representative of an RGB image. The image data 220 is received from a computing device 210 that is communicatively coupled to, or forms part of, the apparatus 205. The image to be processed is an image to be printed on a print medium by a printing device 270. In FIG. 2, the apparatus 205, via the controller 225, applies one or more “mask” functions (i.e. halftone patterns) to the image data. An example of a function may be a halftoning mask of halftoning pattern. A mask function transforms the received image data according to a mask pattern and outputs print data. The print data is used to control the firing of nozzles on one or more printheads. An example of a mask pattern may be a halftone pattern. Once the one or more mask functions have been applied to the image data 220, print data is made available to the printing device interface 260, which is arranged to send the print data to the printing device 270. The printing device 270 is configured to print a portion of the image.

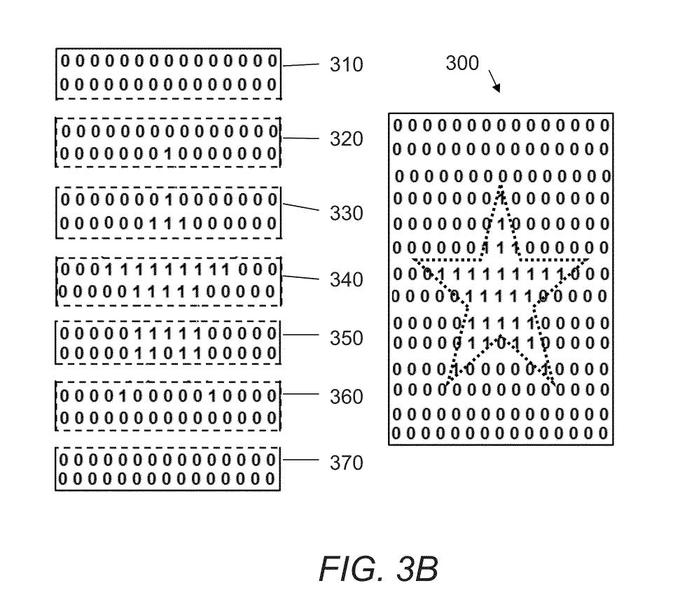

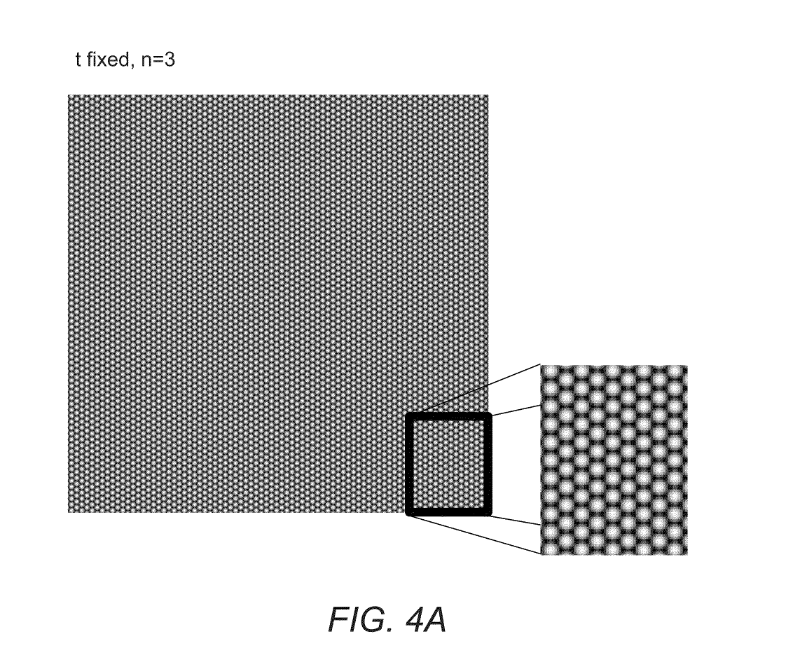

FIG. 3A shows an example image 300 to be printed. The image 300 may be split into a plurality of regions 310-370. Each region corresponds to a portion of the image 300 to be printed. Each region is represented by image data which may be processed to obtain print data used for printing each portion of the image 300. Image data can include the RGB colour output at each pixel in a digital image. Image processing is done to convert the RGB colour outputs into equivalent printable inks, such as CMYK colour outputs. Once image data is processed to obtain print data, the print data may provide the amount of each (CMYK) ink to be deposited at each pixel to achieve the printable colour desired at each pixel. The portions of image data altogether represent the entire image 300 to be printed. For example, a mask function or halftone pattern may be applied to the image data to obtain the print data. Print data may relate to processed image data. The image data may be processed by applying a function such as a halftone mask or pattern to the image data.

FIG. 3B shows example portions of mask data corresponding to the portions of the image 310-370 shown in FIG. 3A to be printed. The one or more portions of mask data are applied to the corresponding portions of image data to obtain print data. The mask data may contain lines of binary code in 1's and 0's controlling the pixels to be printed, wherein a 1 represents a pixel to be printed and a 0 represents a pixel that is not to be printed. The example mask data of FIG. 3B relates to an outline of a star and when this mask data is applied to image data, the image data within the star outline is printable. In this way, each portion of image data may be processed, such as via application of a mask function, to obtain print data for each region of the image. The print data controls the printable pixels of an image.

A halftone pattern can be obtained using a mask function. An example mask function is a quasicrystal function. A halftone pattern represents mask data to be applied to image data. A halftone pattern will possess a halftone pattern which relates to which pixels are printed. The halftone pattern itself may have a series of binary 1's and 0's corresponding to each pixel in the image to be printed, or may have a range of values between 0 and 1 for each pixel to be printed. If the latter, the pattern values for each pixel are compared to a set threshold value, and if the pattern value is higher than the threshold value the pixel is printed; if lower than the threshold value the pixel is not printed.

In certain examples the halftone pattern is obtained using a quasicrystal function. The quasicrystal function may have an arbitrary range depending on its parameters and design and the frequency of values on a uniform discretization of this range may also be non-uniform. Values in a halftone pattern have to be uniformly distributed as they serve to distribute drop states according to an ink-vector or Neugebauer Primary area coverage “NPac” that defines a state or ink probability and this distribution holds if all values in the halftone pattern are equally likely. In order for pattern values to be uniform, the quasicrystal function result is compared to a look-up-table and compensated, for making the pattern values uniform. This uniformity discussed refers to the frequency of values obtained rather than directly relating to the range of values, i.e. the uniformity of the distribution of values for a given range. In order to derive such a look-up-table, the quasicrystal function is computed for a small area of [x, y] values, e.g. 128×128 or 256×256, the values in the resulting matrix are normalized (or scaled) to the range of the desired halftone patterning (e.g. [0 to 255] for an 8 bit pipeline, or [0 to 4095] for a 12 bit one) and its N quantiles are computed, with N depending again on the halftone precision (e.g. N=255 for an 8 bit pipline or N=4095 for a 12 bit one). The result is the look-up-table based on which if a quasicrystal value falls in bin i, it is mapped to value Nᵢ of the quantile table. This ensures that the final halftone pattern's values have the correct range and a uniform distribution.

The halftoning methods described herein by way of example are based on using quasicrystals and quasicrystal functions. Quasicrystal functions are used herein to output non-periodic patterns that possess a structured character. For example, such a pattern is ordered but does not line up perfectly with a shifted copy of itself. Quasicrystals represent a class of functions that result in parametrisable overall patterns. A parametrisable pattern is one that may be described by a set of parameters which may be inputted into a mathematical function. For example, parametrisation in relation to halftoning is the process of defining variables to describe a halftone pattern based on a set of co-ordinates, for example which may relate to the resulting structure over some area (or [x,y] parameters of the quasicrystal function), i.e. the parameters of the quasicrystal function that determine the overall spatial structure once computed over a given area (of [x,y] parameters).

Quasicrystals form an infinite class of functions that correspond to an infinite set of patterns. Quasicrystal functions represent a class of mathematical functions that describe non-periodic patterns that does not line up perfectly with a shifted copy of themselves. Until now, quasicrystal functions have been used for modelling the atomic structure of certain materials. Some quasicrystal functions are described herein and are used to generate a quasicrystal pattern. Since there are many quasicrystal functions no limitation on quasicrystal functions for halftoning is implied based on the limited disclosed functions. It is possible that any quasicrystal function may be used to generate a halftone matrix. In this sense, the quasicrystal functions may be seen as halftone pattern generating functions or “mask functions” which output a halftone pattern when computed over some area. The halftone patterns which may be generated using the quasicrystal functions may be applied to image data as a halftone “mask” or “screen” on the fly or in situ. The present disclosure does not require for a pre-generated matrix for halftoning. The patterns generated are structured and parametrisable, i.e. the patterns are ordered but non-periodic, and may be parametrised. The structure of the patterns generated depend on parameters of those functions used to generate the patterns.

A quasicrystal function comprises a summation series of periodic functions. The periodic functions may be trigonometric, algebraic, polynomial, power, logarithmic etc. Examples of trigonometric functions are sine and cosine functions. Examples of algebraic functions are piecewise-linear sawtooth or squarewave functions. Examples of quasicrystal functions are given later in this description. The quasicrystal function is used to output threshold values for the halftone pattern by superimposing a series of periodic functions. Any combination of the periodic functions is permitted, for example the summation series may comprise cosine and sine functions, or sawtooth and squarewave functions, or cosine and squarewave functions to name a few.

Quasicrystal patterns are generated by superimposing a series of periodic wave functions. The patterns can be computed directly from any given location, for example described by “x” and “y” co-ordinates in a two-dimensional plane. The location may relate to the position of a pixel in a print or image. A print (or image) may comprise tens of thousands of halftone pixels squared. For example, a pattern value or threshold value for any given pixel may be computed directly from that pixel's absolute co-ordinates within the print (or image), and some fixed parameters of the quasicrystal function. The fixed parameters may relate to a constant offset value or the number of wave functions used in the pattern generation. Certain parameters of the quasicrystal function may be fixed for a given print or printing system.

To generate a halftone threshold value using a quasicrystal function, a single pixel is chosen and then a single halftone threshold value is found for that pixel using the quasicrystal function. The single halftone threshold value is independent of colorant, i.e. one threshold value is needed regardless of the number of colorants being used in the case of a HANS pipeline, while for a traditional, colorant-space based pipeline multiple, one-per-colorant threshold values may be needed and can be had by appropriate rotations of the quasicrystal threshold values. The family of quasicrystal functions is not uniquely determined, however one example of a quasicrystal function is given below in equation (1.1).

Q_{n,t}(x,y)=Σᵢ cos(sin(θᵢ)x+cos(θᵢy+t)) (1.1)

The quasicrystal halftoning patterns are computed analytically. The infinite set of quasicrystal patterns that may be obtained using quasicrystal functions depend on parameters such a constant offset value (“t”), and the number of wave functions (“n”) added or summed in the series for the pattern generation. The overall resulting pattern of the function can be seen when computing the above values for some area of spatial locations (“x” and “y” co-ordinates). All parameters of a quasicrystal function may be varied to result in different patterns being generated, each having different visual properties. In this way an infinite set of quasicrystal patterns are achievable. As an example of the flexibility of quasicrystals to produce an infinite number of quasicrystal patterns, for a given print or printing system the “n” and “t” parameters may be fixed choosing some continuous range of “x” and “y” co-ordinates, and computing the values of the quasicrystal function to produce one quasicrystal pattern. Note that at any single pixel the quasicrystal function will output a single value, when this is extended over some area a pattern is formed for a range of x and y co-ordinates. Then for the different printing system or a different image content, a different set of “n” and “t” parameters may be chosen to produce a second, distinct quasicrystal function which results in a different pattern to the first. For example, the quasicrystal pattern may be shifted along at least one spatial direction.

The quasicrystal function shown above in equation (1.1) is now described. In this example, the threshold value “Q” for a chosen pixel is found using fixed parameters “n” and “t” for a single pixel having known “x” and “y” co-ordinates. The summation series E of periodic functions in this example comprises sine and cosine wave functions. The summation value i is an increasing integer value from 1 to n and wherein i=1 relates to the first term in the summation series, i=2 relates to the second term in the summation series and so on. The phase of the periodic wave functions in this example is described by θᵢ and depends upon the parameter “n” which is fixed for a given quasicrystal function. The phase term θᵢ is defined in the range 0 to

$$π ( 1 - \frac{1}{n} )$$

in step-sizes of

$$\frac{π}{n}$$

such that

$$θ = [ 0 , \frac{π}{n} , 2 \frac{π}{n} , … , . π ( 1 - \frac{1}{n} ) ]$$

for positive integer values of n. This is simply a uniform sampling over a range of [0 . . . π-step] since in the case of the trigonometric functions the value at 0 and π is the same. Note that the parameter n cannot take integer values below 1 because it relates to the number of waves added over the summation series. The off-set parameter t can be described as controlling a shift of each wave function and can take any value, i.e. the threshold value at each point in the quasicrystal pattern or the “greyness” of each pixel in the pattern without significantly modifying the structure of the pattern itself, and manifesting as an amplitude and spatial shift in the pattern. The off-set parameter does not have to be an integer value and may be any positive value, for example, t=0 or t=2.5 or t=5.

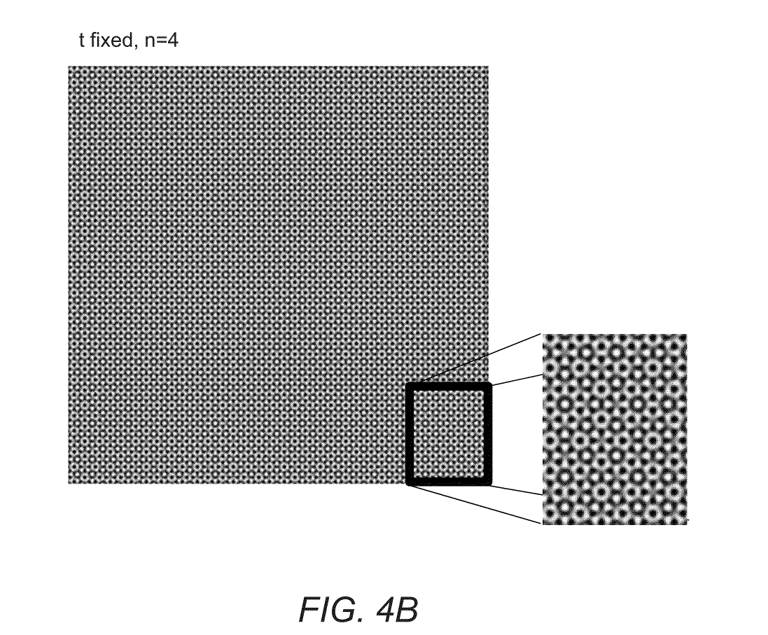

FIGS. 4A-D show examples of quasicrystal halftone patterns generated using the above quasicrystal equation (1.1). The halftone patterns shown have been scaled to an 8-bit range and have had the non-uniform to uniform distribution look-up-table transform applied to ensure a uniform value distribution. The “normalisation” or scaling and redistribution block will be described below. The halftone patterns in FIGS. 4A-D have been generated using the above quasicrystal function (1.1) for fixed parameter t wherein the off-set parameter t=0, and for varying n, over an area of 256 by 256 pixels (so varying both x and y from 0 to 255 each).

In the examples of FIGS. 4A-D, the parameter for the number of waves n has been varied as follows: n=3 for the halftone pattern shown in FIG. 4A; n=4 for the halftone pattern shown in FIG. 4B; n=6 for the halftone pattern shown in FIG. 4C; and n=8 for the halftone pattern shown in FIG. 4D. As can be observed, when n is small the resulting pattern is simpler and resembles more that of a plain regular halftone screen, while for larger n the pattern becomes more intricate and the lack of perfect regularity more apparent, i.e. compare the quasicrystal halftone patterns for n=3 and n=8 in FIGS. 4A and 4D respectively.

For smaller values of n, the periodicity of the quasicrystal pattern appears higher (i.e. more periodic) and more ordered, than for higher values of n. For example, FIGS. 4A and 4D illustrate a comparison of the quasicrystal patterns for n=3 and n=8 respectively. As parameter n is varied for higher values of n the individual the pattern increases in complexity and other variations on structure are introduced. For example, the quasicrystal pattern of FIG. 4D has additional visual features when compared to the quasicrystal pattern of FIG. 4A. The quasicrystal pattern of FIG. 4A has been generated using n=3 and the pattern appears more periodic than the quasicrystal pattern of FIG. 4D which has been generated using n=8. For lower values of n, the quasicrystal pattern will appear more periodic and structured than for higher values of n, because the step size

$$( i . e . \frac{π}{n} )$$

will be larger for lower values of n coupled with the lower number of periodic functions summed. As a result, each pixel may contain “less information” on pattern structure and the pattern may therefore be less varied in appearance. In this instance, for lower values of n, the halftone patterns may appear similar to the halftone patterns derived using cluster-dot halftoning or amplitude-modulated halftone screening but with varying degrees of detail. Cluster-dot halftoning may also hide defects, however the cluster-dot matrices are perfectly regular clusters (concentric areas) and produce undesirable effects when printing lines or line drawings. In contrast, the quasicrystal halftones described herein (although the quasicrystal patterns may have a resemblance to cluster-dot halftoning) have a nature of irregularity that mitigates issues that cluster-dot halftoning creates with lines or line drawings. While the quasicrystal model using the equation 1.1 is strictly non-regular, given the scaling and redistribution block and the need to make the distribution uniform, at low n values (e.g. n=3) and low bit-depths the final pattern may appear mostly regular. For larger values of n the halftone pattern will become finer and less clustered. In addition, for larger values of n such as for the pattern generated in FIG. 4D, the pattern generated may be observed to exhibit “patterns within patterns”. For example, the “patterns within patterns” may change depending on which part of the image is being observed by the human eye and may depending on the eye's observing distance from the quasicrystal pattern. The differently observed “patterns within patterns” may depend upon the viewing distance or may depend upon the spatial frequency which the human eye system can detect and interpret. It could be said that each quasicrystal pattern that is generated from a quasicrystal function is a quasiperiodic pattern. A quasiperiodic pattern is one that does not line up perfectly with a shifted copy of itself. Quasiperiodic patterns applied as halftone screens result in some degree of perceived “unpredictability” in a halftoned image once the quasicrystal pattern has been used to halftone the image.

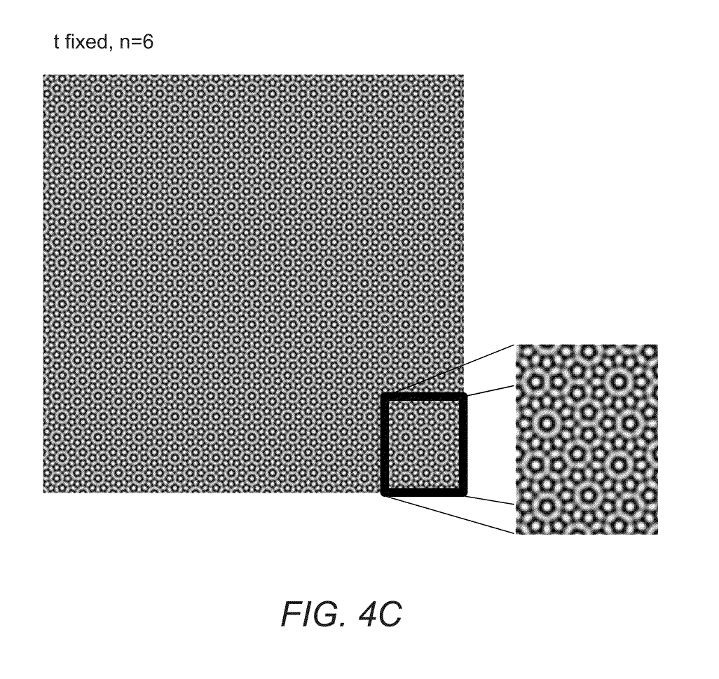

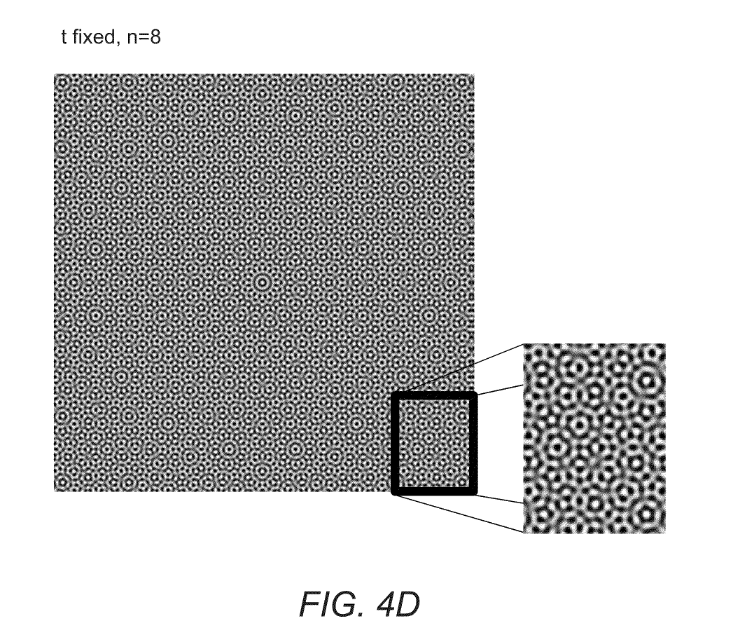

FIGS. 5A and 5B show examples of quasicrystal patterns generated using the above quasicrystal equation (1.1) and where parameter n is fixed and parameter t is varied, computing values again over a 256×256 window of pixels. In the example patterns shown in FIGS. 5A and 5B the parameters have the number of waves is fixed to n=7. The off-set parameter t is varied as follows: t=0 for the pattern shown in FIG. 5A; and t=2.5 for the pattern shown in FIG. 5B. As can be observed from the patterns in FIGS. 5A and 5B, varying the off-set parameter does not cause as noticeable effect in the visual properties of the patterns generated when compared to those patterns generated by varying on the n parameter for the number of waves. Varying the t parameter whilst keeping the other variables of the quasicrystal function fixed, does not create a significant change in the size of the individual crystals. Modifying the t-parameter introduces subtle changes in the halftone pattern without affecting the overall apparent pattern structure. The halftone patterns generated for different “t” values may be observed to have subtle amplitude changes in the threshold values at each pixel in addition to spatial changes or shifts that may be seen as minute pattern changes. The effect of varying the t-parameter on the halftone patterns generated is smaller than the effect which may be observed for varying the n-parameter.

When the above quasicrystal function (1.1) is used to generate a quasicrystal pattern, it may be observed that varying the parameter n for the number of waves produces a more noticeable effect or change to the quasicrystal pattern generated when compared to when the off-set parameter t is varied, whilst keeping all other parameters fixed (i.e. vary n and fix x, y and t; or vary t and fix x, y and n).

FIGS. 5C and 5D show magnified sections of the quasicrystal patterns generated and shown in FIGS. 5A and 5B respectively. It can be seen that varying the off-set parameter between t=0 and t=2.5 for these examples results in the pattern of FIG. 5D maintaining the overall texture of the pattern of FIG. 5C while introducing shifts and changes of a minor scale to the threshold values.

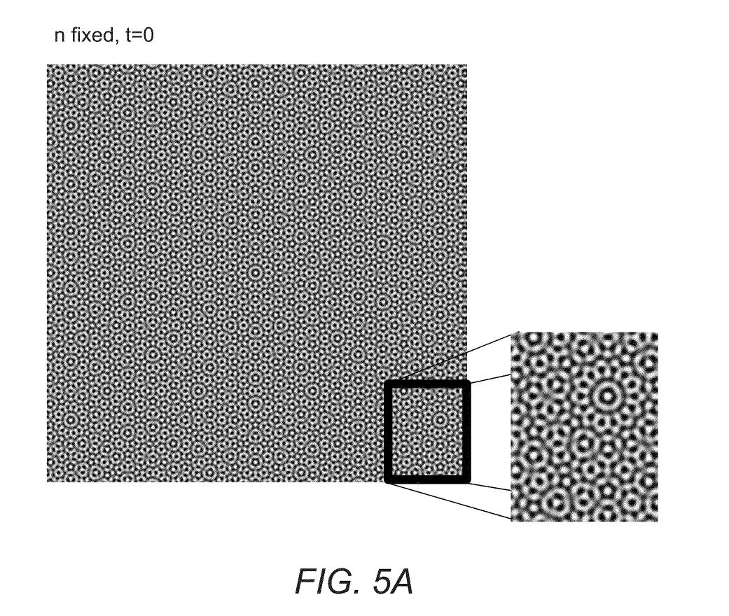

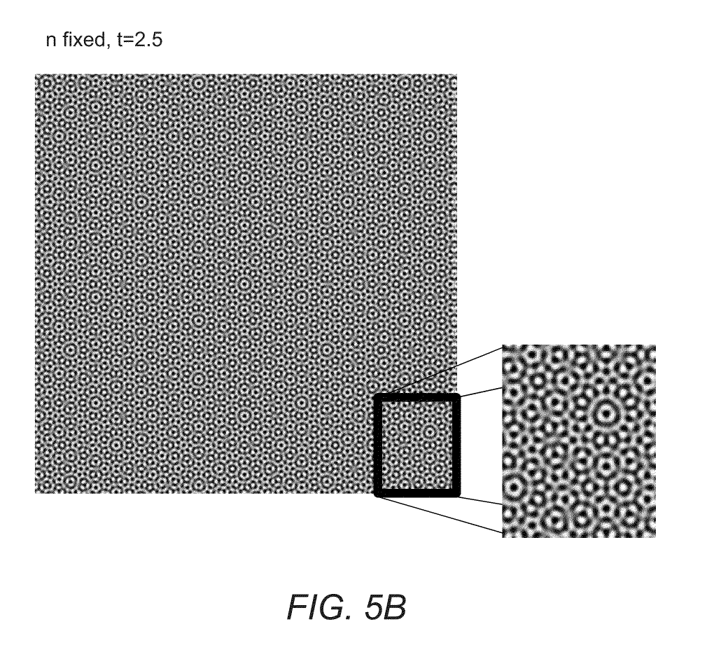

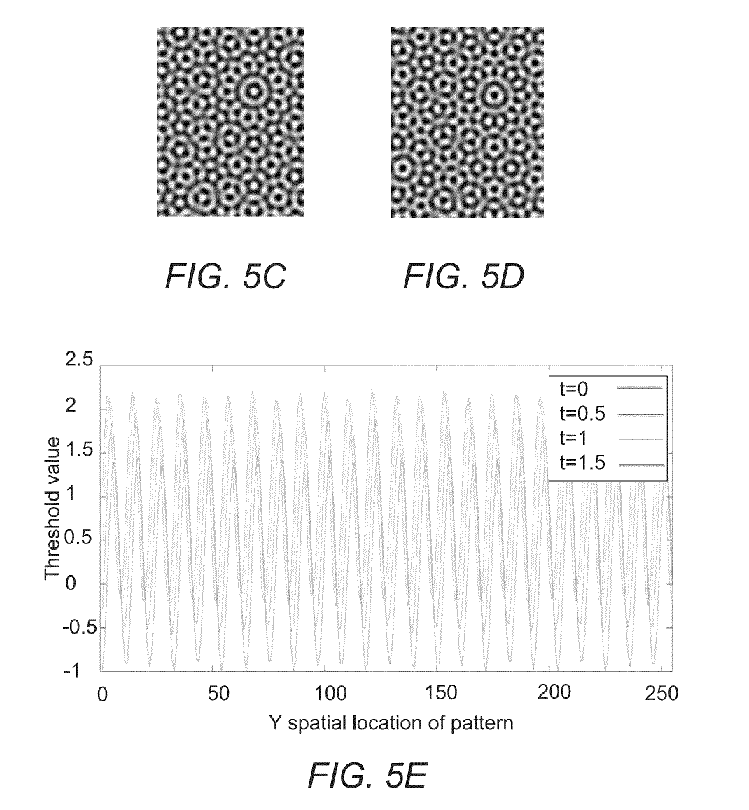

An example method that may be used for generating a quasicrystal pattern is described with reference to FIG. 6A. FIG. 6A shows a flow chart for generating a quasicrystal pattern. Each block in the method is described in turn.

In block S1, the quasicrystal function is selected and the parameters for the number of waves n and the off-set parameter t are chosen. For each image to be printed, the n and t parameters are constant, i.e. fixed. If other images for the same printing system or other print system need to be halftoned then the n and t parameters may be changed.

In block S2, a single pixel is chosen having a known location in the image which defines the x and y co-ordinate values. Once all of the parameter values (n, t, x, y) are determined, the parameter values are inputted into the quasicrystal function. A threshold value Q(x,y) is computed for the pixel using the quasicrystal function and summation of the wave functions over the number of waves n specified. The computed Q(x,y) value for the pixel (and each subsequent pixel) may vary in terms of its range of values over some spatial area, depending on the wave components and the parameters n and t, i.e. the Q-values over a [0, 255] area squared for example.

In block S3, the threshold value of the next pixel is computed using the next pixel's x and y co-ordinates which are inputted into the quasicrystal function using the same n and t parameters as defined in block S1. Similarly as in block S2, the next pixel's threshold value Q is computed and will likewise vary in terms of its range.

In block S4, the threshold values Q for each of the remaining pixels are computed by repeating the previous block S3. For example, each pixel may have a given x and y co-ordinate value which may be inputted into the quasicrystal function and summation series to calculate a Q-value for each pixel. Again, the computed threshold values for the remaining pixels are non-uniform and their range vary depending on the n and t parameters.

In block S5, the quasicrystal pattern generated is outputted. The quasicrystal pattern at this stage is described by a non-uniform matrix which can be further processed or scaled to produce a uniform quasicrystal halftone pattern.

FIG. 5E shows an example plot wherein the t-parameter has been varied whilst keeping the n-parameter constant. This example relates to the quasicrystal function of equation (1.1). For each t-parameter value shown in the plot, a quasicrystal pattern was generated and a “column” of threshold values through the pattern selected to obtain the variation in threshold value along a line throughout the pattern, i.e. varying in the y direction for a fixed x co-ordinate value. The same line (column) was selected consistently between the quasicrystal patterns generated for t=0, 0.5, 1 and 1.5. The example shown relates to a bit-depth of 256 and was computed over an area of 256×256 pixels ([x, y] parameters) as shown along the y-axis of the plot. Moving along the y-axis relates to each pixel for a fixed x-value, and shows the spatial variation along a line within the pattern for each threshold value at each pixel. It can be observed that for smallest values of the t-parameter, there is a lower amplitude variation throughout the pattern where the threshold values are generally lower. For example, for t=0 the threshold values vary approximately between −1 and 1.5; for t=0.5 the threshold values vary approximately between −0.5 and 2; and for t=1 (and t=1.5) the threshold values vary approximately between −0.25 and 2.25. FIG. 5E shows the effect that varying the t-parameter has on the amplitude and spatial variation throughout each quasicrystal pattern. It may be observed that there is a subtle change between each t-value pattern however the overall pattern structure itself is not significantly altered, the t-parameter introduces small variations in each pattern.

FIG. 6B shows an example quasicrystal pattern that may be outputted using the method of FIG. 6A and the quasicrystal function described above in equation (1.1). The quasicrystal pattern which is outputted is non-uniform. A non-uniform pattern has a non-uniform distribution of threshold values which in turn is not suitable for a halftone screen. The quasicrystal pattern is scaled or transformed such that the distribution of threshold values in the pattern may be uniform for halftoning purposes. It may then be suitable for use as a halftone screen or for applying the halftone pattern to image data for creating print data to print the image.

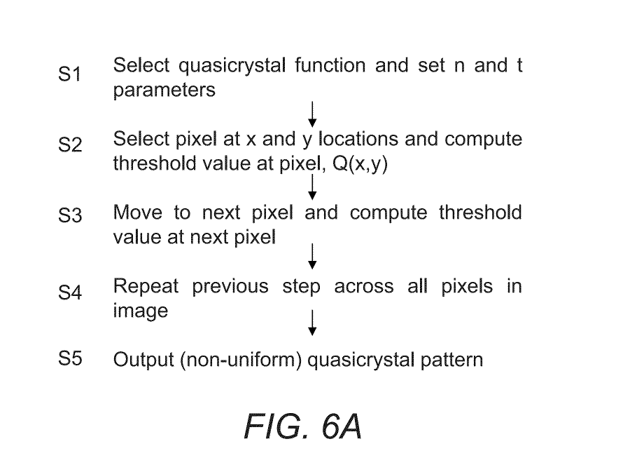

FIG. 6C shows an example of a non-uniform distribution of threshold values between 0 and 1, which is the result of computing the histogram of values from the quasicrystal pattern of FIG. 6B. This particular example relates to n=7 and t=0. The above quasicrystal function (1.1) computes a distribution of values that are non-uniform as shown by the histogram of FIG. 6C. Since a halftone pattern is expected to have the same frequency of each Q value outputted, an additional transformation is performed. This effectively maps the non-uniform Q values from the range of 0 to 1 with their respective frequencies onto a uniformly distributed set of values on a chosen range suitable for the use of the halftone threshold values. This makes the generation of every threshold value equally likely for the halftoning process. The range of the halftone pattern may correspond to an 8 bit mask or pattern in which the Q values are mapped onto a range between 0 and 255. Alternately, the size of the halftone pattern may be for a 12 bit mask or pattern in which instance the Q values may be mapped onto a range between 0 and 4096. Transforming the original values of 0 to 1 to the above range of 0 to 255 or 0 to 4095 is effectively a scaling and redistribution and is now described with reference to FIG. 7.

The threshold Q-values at each pixel are normalised for a given resolution. This computation is performed once for a given combination of n and t parameters on an area of the (x,y) values of the quasicrystal function, for example for equation (1.1). The area of (x,y) values chosen depends on a desired encoding precision or resolution. The resolution area relates to the size of the sample which is to be scaled. For example the resolution area may correspond to an 8 bit mask or pattern that has a range of 0 to 255 for which a suitable area may be e.g. 256 pixels×256 pixels, or for a 16 bit mask or pattern that has a range of 0 to 65535 a sufficient area may be 512 pixels×512 pixels. The area needed to determine the quantiles used to achieve a uniform distribution also depends on the complexity of the pattern, such that for a quasicrystal function of the kind described in Eq. 1.1 and parameter n=3 a smaller area, e.g. 128×128 pixels may suffice, while for more complex patterns where n>3 a bigger area may be needed. This scaling and redistribution is needed since the above example parameters of the quasicrystal function (1.1) will compute Q values between 0 and 1 at any given location in the (x, y) plane and where the computed Q values are non-uniform in frequency over an area. For example, before applying the above post-processing (scaling and converting to a uniform distribution) to the threshold values Q, which are computed for chosen n and t parameters, the outputted threshold values calculated in each step-size (where the step-size is determined by the number of components n and the periodicity of the quasicrystal function, such that for Eq. (1.1) this is

$$\frac{π}{n} )$$

has varying frequencies of distribution. A halftone matrix is expected to have the same frequency of values for each step-size. A method for performing the post-processing on the non-uniform Q-values (outputted using the quasicrystal function) includes using a look-up-table (LUT). An example method for transforming a non-uniform pattern to a uniform pattern is now described.

FIG. 7 is a flow chart that shows a method for obtaining a uniformly distributed halftone pattern for halftoning. This includes pre-computing the look-up-table (LUT) and may be performed off-line as part of setting up parameters for a quasicrystal halftoning process that is fully defined by the quasicrystal function Q, parameters n and t as well as the LUT itself. Given this set of parameters [Q, n, t, LUT], a quasicrystal threshold value can be computed at any location [x, y] independently of other pixels at other [x,y] locations.

In block Sa, a representative area of the quasicrystal pattern is chosen which corresponds to the non-uniform Q-values which have been outputted using the quasicrystal function as described in Eq. (1.1).

In block Sb, the resolution of the halftone pattern is chosen having the desired bit-depth of the halftone pattern.

In block Sc, the empirical cumulative distribution functions is computed and quantiles of the outputted Q-values and respective frequencies are computed for the selected resolution of halftone pattern. For example, there may be 256 quantiles for an 8-bit halftone pattern, mask or matrix.

In block Sd, each quantile is assigned to the respective 8-bit value for example. The result of this assignment is that the quantiles of the Q-values are mapped to their respective ranges and respective halftone threshold values. A scaling and redistribution look-up-table (LUT) is computed for the chosen bit-depth and n and t parameters.

The above process ensures a uniform threshold value distribution over the representative area selected from the quasicrystal pattern. A uniform threshold value distribution may be obtained via a transformation of non-uniform threshold values to uniform threshold values, for example using a scaling and redistribution LUT. The mapping itself may be pre-computed depending on Q and the n and t parameters chosen and the uniformly distributed threshold values can be mapped in-situ accordingly from an LUT. Such a post-processing LUT may be obtained in advance for each resolution value desired for known parameter values of n and t. Each LUT comprises a mapping from non-uniform intervals (determined by the N quantiles) corresponding to the native frequencies of Q, to the a uniform frequency of threshold values at the desired bit-depth range. A LUT may be applied to generated quasicrystal patterns via the non-uniform threshold values Q(x,y).

Computing the non-uniform threshold values Q(x,y) from the quasicrystal function, and subsequently using a 1D LUT, can be performed at any single pixel and independently of all other pixels. This may be similar to where a threshold matrix may be applied. Use of a 1D LUT may use a threshold matrix pre-computation off-line, while at the point of applying the above described quasicrystal halftoning process no spatial pattern needs to exist. The halftoning pattern that results over larger areas using this approach is primarily determined by the number of waves n in the summation of the quasicrystal function, for example equation (1.1), as well as the nature of the periodic components in Q itself (trigonometric in this example) and to a lesser degree by the constant offset value t.

Using an available scaling and redistribution LUT the non-uniform threshold values of a generated quasicrystal pattern may become uniform threshold values.

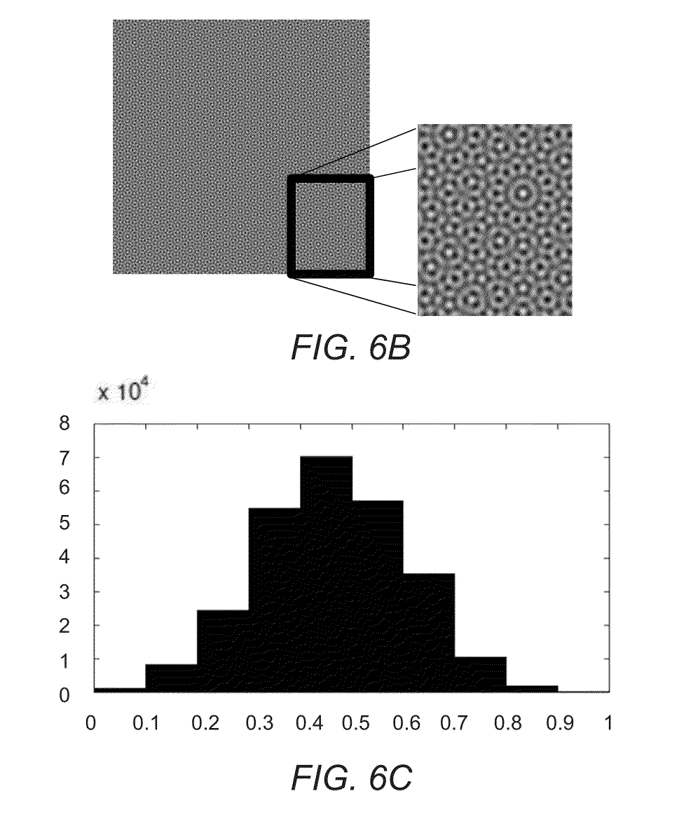

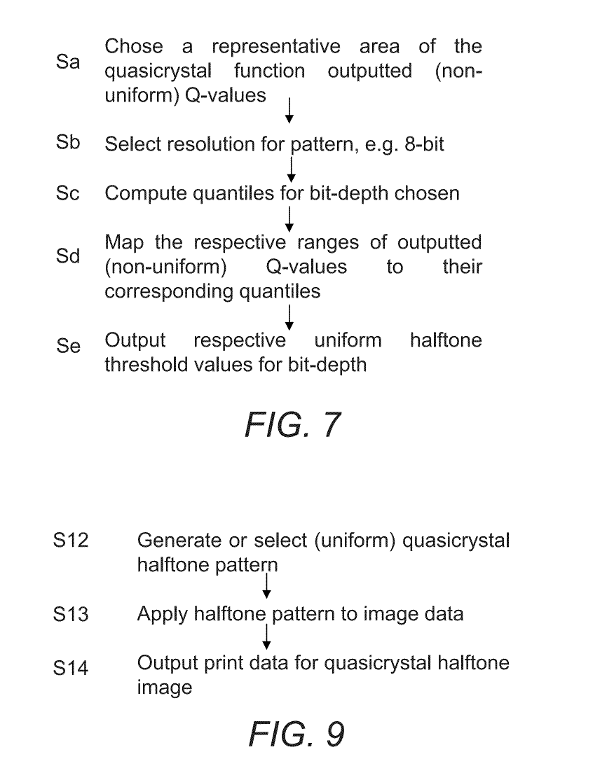

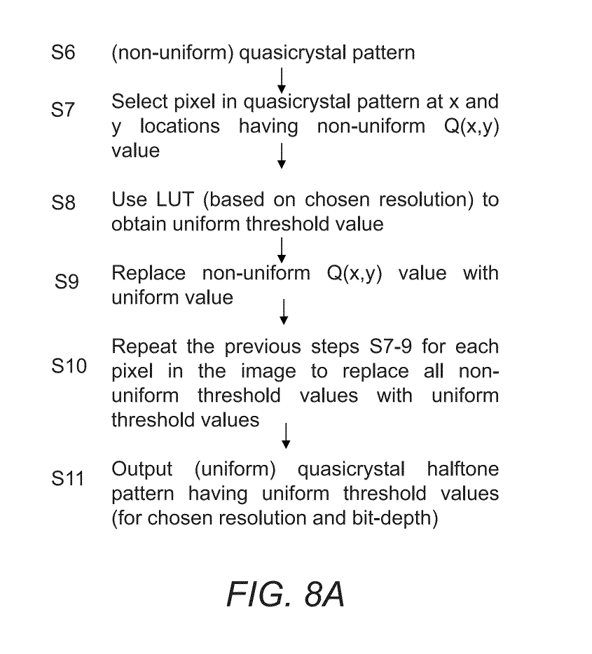

FIG. 8A shows a method for obtaining uniform threshold values of the quasicrystal pattern generated.

In block S6, the quasicrystal pattern is selected.

In block S7, a single pixel in the quasicrystal pattern is chosen having known x and y values. The LUT is independent of the [x,y] values or pixel location, however the LUT does depend upon the actual pixel value since it depends upon the Q-value and n and t parameters.

In block S8, a post-processing look-up-table (LUT) is referenced to obtain a modified threshold value for the single pixel.

In block 9, the non-uniform threshold value is replaced with a uniform threshold value from the LUT. The LUT being such that over multiple pixel locations the distribution of values will be uniform.

In block 10, the previous blocks of blocks S7-S9 are repeated for each pixel in the image to obtain uniform threshold values for every pixel in the image. Each non-uniform threshold value is replaced with a uniform threshold value that further guarantees a uniform distribution when applied to multiple pixels over larger areas.

In block 11, the now uniform quasicrystal halftone pattern is outputted. Since the LUT corresponds to a given bit-depth, the outputted quasicrystal halftone pattern corresponds to the bit-depth of the LUT selected.

FIG. 8B shows an example of a quasicrystal pattern that is scaled to an 8 bit precision and transformed using an appropriate LUT to make the distribution of all 8 bit values uniform. The scaled and uniform quasicrystal pattern shown in FIG. 8B corresponds to a uniform transformation of the quasicrystal pattern shown in FIG. 8A.

As a comparison to a non-uniform pattern, FIG. 8C shows a uniform histogram of the quasicrystal pattern in 8B. In this example the frequency of each threshold value is uniform, i.e. every threshold value computed by means of the quasicrystal function is equally likely.

A halftone pattern may then be applied in the context of a HANS color separation where every color is defined by a distribution of Neugebauer Primaries (NPs) and their relative area coverage, defining an NP area coverage vector or NPac, which can be considered a probability of ink-drop-overprint states or NPs. For convenience the NPac can be represented as a cumulative distribution so that for an NPac of 50% C1 (one drop of Cyan) and 50% C1M1 (one drop of Cyan overprinting one drop of Magenta), the Cumulative NPac (cNPac) is written as [C1: 127; C1M1: 255] assuming an 8 bit encoding. Each threshold value in the quasicrystal pattern is then compared to the area coverage values to obtain the per-pixel per-ink halftone value. If the threshold value is greater than the set limiting value (e.g. above 127), a “1” is placed in the Cyan and Magenta channels indicating a C1M1 state at that pixel is to be printed; if the uniform threshold value is less than the set limiting value (e.g. up to 127), a 1 is placed in the cyan channel to indicate that the pixel at that location is to be printed as a single drop of Cyan. The halftone with binary 1's and 0's per ink-channel is then a print-ready halftone image. The halftoned image may then be printed.

Before a halftone image may be printed, print data representing the halftone image is obtained. In the following example, the print data is obtained by applying a quasicrystal halftone pattern to the image data and will now be described.

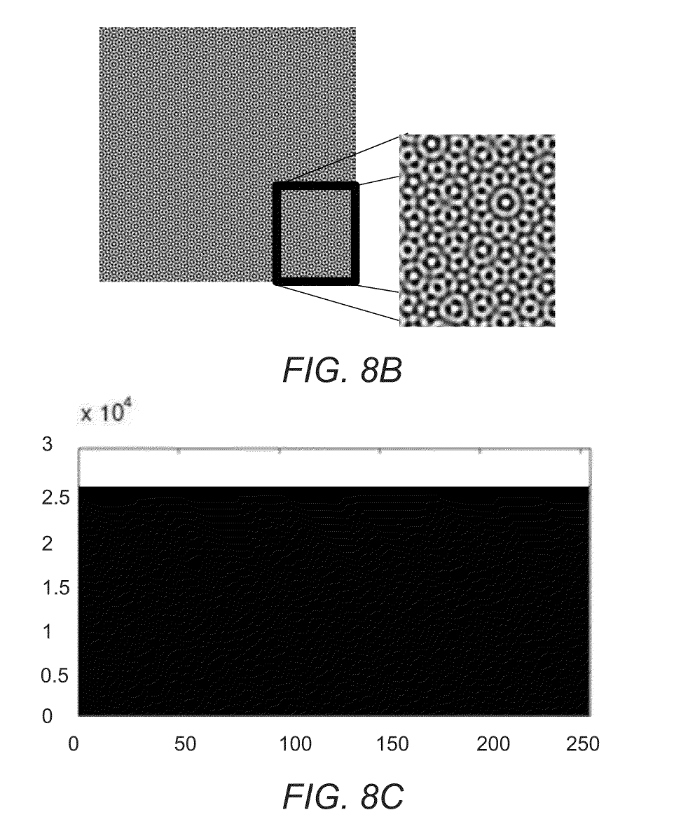

FIG. 9 shows an example method of outputting print data using a quasicrystal halftone pattern. In block S12, the quasicrystal halftone pattern is generated. The quasicrystal halftone pattern has a uniform distribution of threshold values across all pixels. In the next block S13, the quasicrystal halftone pattern is applied to image data representing an image to be printed. In block S14, the print data is outputted based on the processed image data which has been halftoned using the quasicrystal halftoning approach. The print data may then be used to print the image on a printing system.

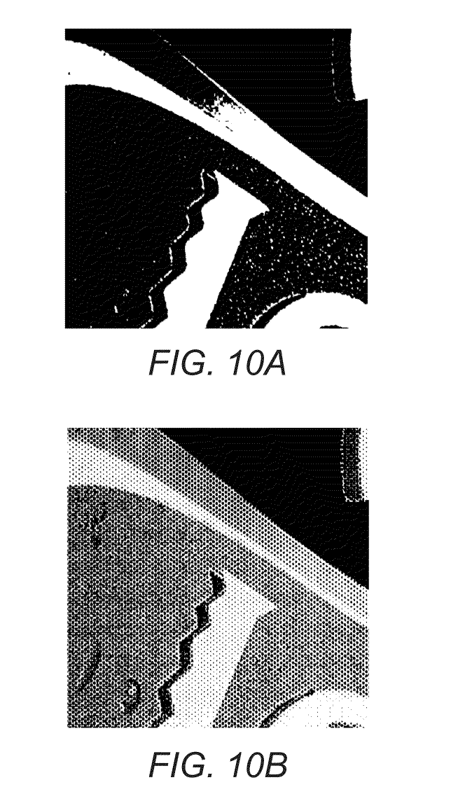

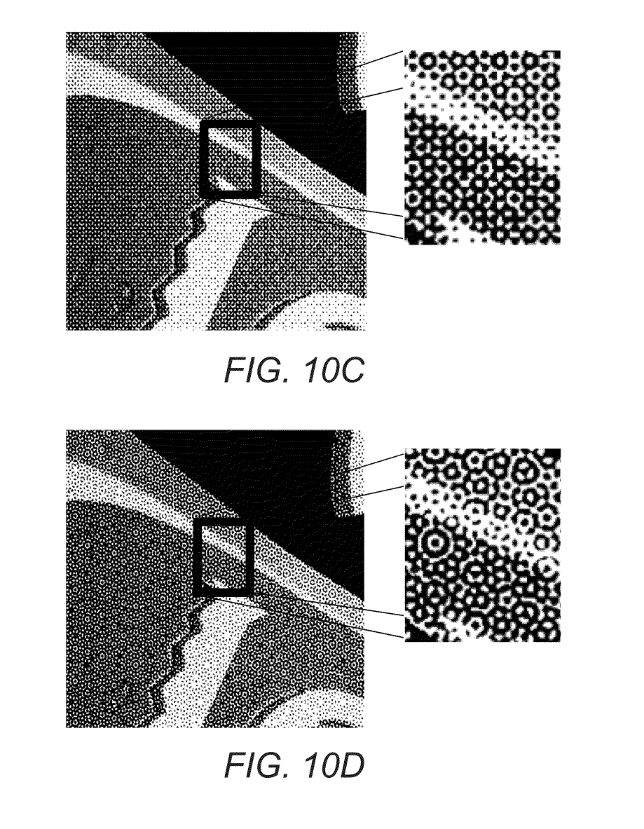

FIGS. 10A to 10D show images to be printed. FIG. 10A shows an example of an image to be printed which may be a contone RGB image. Once the image has been processed and a quasicrystal halftone pattern applied to the image data representing the image, the image may be output as a halftone image. In other examples, a color separation may be coupled with the quasicrystal halftone pattern for processing the image. For example, an RGB continuous tone image is converted using color separation to the domain of a printer's color separation. A color separation may be defined as NPacs in a HANS printing pipeline or ink-vectors in other (non-HANS) printing systems. The image data representing the image, which may be a continuous tone RGB image, is then outputted as a halftone image which includes the color separation.

Example halftone images to be printed are shown in FIGS. 10B-D. The halftone images of FIGS. 10B-D represent different quasicrystal halftone patterns using equation (1.1) which have been applied to the image data of FIG. 10A. FIG. 10B has been obtained for three wave components for parameter n=3. This halftone image corresponds to the quasicrystal pattern or threshold matrix simulated as shown in FIG. 4A and with t=1.

FIG. 10C has been obtained for four wave components for parameter n=4. This halftone image corresponds to the quasicrystal pattern or threshold matrix simulated as shown in FIG. 4B and with t=1.

FIG. 10D has been obtained for seven wave components for parameter n=7. This halftone image also corresponds to a quasicrystal pattern with t=1.

The family of quasicrystal functions is not uniquely determined. Instead of the sine or cosine functions described in equation (1.1), simple piece-wise linear functions may be used. For example, other linear functions may include sawtooth or squarewave functions. Other examples of a quasicrystal function are shown below in equations (1.2) and (1.3). Since the following quasicrystal functions also output values on different ranges, like those in Eq. (1.1) depending on all their parameters and composition, an additional scaling and conversion to a uniform distribution, for example, using a LUT is also needed in the below examples of quasicrystal functions for generating a uniform quasicrystal halftone pattern. This applies for all quasicrystal based functions used to generate a halftone pattern since these types of functions can have any range and any distribution. Therefore the outputted patterns need to be adapted for halftoning purposes. Whilst the patterns generated are not perfectly regular, the distribution of their outputted Q-values over a given area is well behaved (i.e. representative over some area). Therefore a LUT may be used to adapt or compensate the threshold values to make the threshold values uniform and scale the values to a desired range by scaling and redistribution.

Q_{n,t}(x,y)=Σᵢ sawtooth(squarewave(θᵢ)x+sawtooth(θᵢy+t)) (1.2)

Q_{n,t}(x,y)=Σᵢ cos(squarewave(θᵢ)x+cos(θᵢy+t)) (1.3)

In the quasicrystal function defined in equation (1.2), the sawtooth and squarewave functions may have the following forms of equations (1.4) and (1.5).

sawtooth(x)=abs(mod(x,4)−2)−1 (1.4)

squarewave(x)=sign(sin(x)) (1.5)

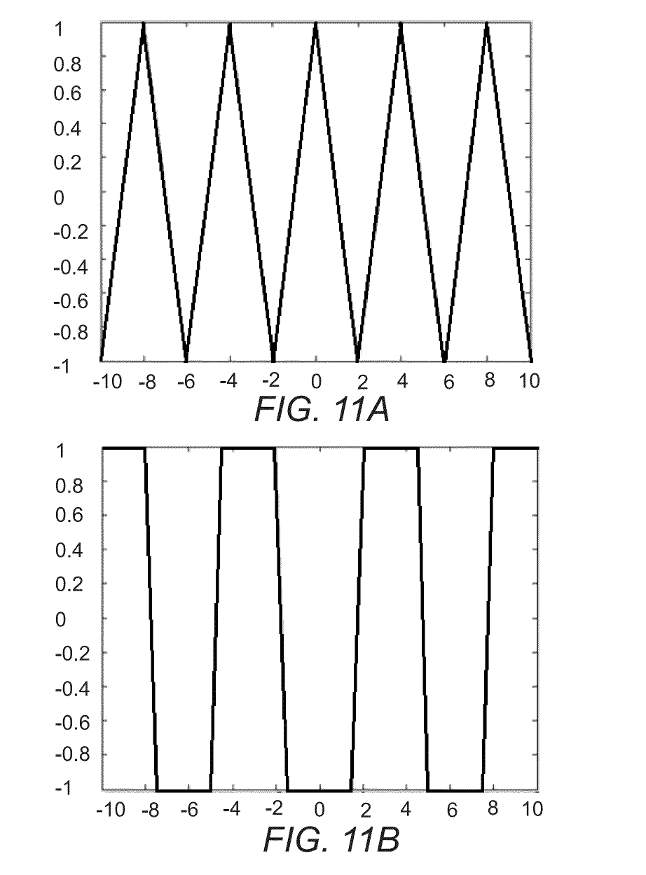

The linear function of equation (1.4) is an example of a “sawtooth zigzag” as shown in FIG. 11A. The absolute value of the modulo operation (modulus after division) of [x modulo 4] results in all values of mod(x,4) to be from 0 to 4, i.e. mod(x,4)ε[0,4), and generates a periodicity of magnitude 4. This is shown in FIG. 11A wherein each saw “tooth” has a width of 4 along the x-direction. Increasing this value causes the sawtooth function to spread out along the x-direction. The sawtooth example of equation (1.4) oscillates between −1 and +1 in the y-direction.

The linear function of equation (1.5) is an example of a “sign” function which returns a positive or negative integer of 1 and wherein the sine function is a shortcut for periodicity, as shown in FIG. 11B. The function of FIG. 11B is generated using

$$sign ( sin ( x - \frac{π}{2} ) ) .$$

Other examples of quasicrystal functions may be found using any combination of the periodic functions such as for example those in equations (1.4) and (1.5). Generate a quasicrystal halftone pattern based on a quasicrystal function uses the principle of superimposing a varying series of periodic functions with offsets and shifts in each component. The periodic functions may be trigonometric such as sine or cosine, or algebraic such as those above in equations (1.4) and (1.5) or other periodic functions. The parameters within the functions may be chosen to give rise to the infinite patterns that may be generated and which may then be used for halftoning.

The methods described in certain examples herein utilise quasicrystal functions for halftoning to hide print defects such as banding artifacts or more conspicuous areas of a printed image that result, for example, from use of a repeating halftone pattern which is applied to image data. It may also be used to have better rendering of light or thin lines which under perfectly regular, traditional, halftone masks or patterns print poorly. The quasicrystal halftoning of the said examples provides a method which allows for a non-periodic halftone threshold value to be computed indefinitely to image data without resulting in the presence of print defects since the quasicrystal halftone pattern does not perfectly line up with a shifted copy of itself. It should be understood from this disclosure that there is no need for a fixed mask for tiling across many slices of image data, instead threshold values may be computed at any location [x,y] indefinitely. A mask or halftone pattern is used to define how an image may be printed. Certain pattern structures described herein, when applied to image data, result in print data and a printed pattern having a unique halftone pattern for each subset of image data.

For example, for halftoning purposes the quasicrystal patterns may be generated for higher values of n in Eq. (1.1) for which a more complicated visual appearance can be found in the patterns themselves. This may further reduce the identification of artificial artifacts in a printed image and therefore improve the visual appearance of the printed image due to the more complicated structure of the quasicrystal halftone pattern used. The algorithms described herein may be implemented in FPGAs or ASICs, or GPUs with massive parallelism and high performance.

In particular examples, certain described patterns effectively hide print defects by having regularity but also varying spatially. In cases where massive parallelism is used to compute a halftone mask or pattern, it is beneficial to be able to halftone content feely without the need to synchronise or replicate threshold matrices. Consistent halftone patterns are achieved regardless of where the content was halftoned, i.e. regardless of the pixel location chosen to generate the quasicrystal halftone function.

The methods described herein allow for the ability to compute threshold values at a single pixel analytically. This allows for in situ at-pixel threshold values without the need for pre-computed and appropriately tiled threshold matrices, i.e. this allows for the ability to compute a threshold pattern “on the fly”. It may be noted that since the pattern is computed on the fly a “pattern” or tile per se is not explicitly computed but rather computed at each single pixel independently from other pixels, i.e. the pattern is the result of an analytic definition at each pixel wherein an overall pattern is that of a halftone mask. This is advantageous over alternative methods that may use a threshold matrix (per colorant in the case of a traditional pipeline or a single one over-all in the case of HANS). The generation of a single threshold value per pixel is particularly well suited for application in a HANS printing pipeline as in this case it is a single threshold value that determines the drop-state (NP) placed at any one halftone pixel. Instead in a traditional pipeline multiple threshold matrices are needed—one per ink-channel—which are then sandwiched together to determine the at-pixel NP to place in the halftone. A HANS printing pipeline uses Halftone Area Neugebauer Separation. HANS is an image processing system using Neugebauer Primaries and Neugebauer Primary area coverages (NPacs) as the domain within which color separation is defined, rather than ink-vectors as is the case in traditional pipelines. A HANS pipeline may be one that optimizes a variety of print attributes such as ink-use, spectral reflectance etc.

Further, the use of quasicrystal functions to generate halftone threshold values provides access to a wide variety of patterns for halftoning. The wide variety of patterns are accessible from the same computational means, i.e. parametrisability. This opens up the possibility to customize halftone screens “on the fly” or in a job-dependent manner. The wide variety of patterns may also be applied to authentication purposes wherein patterns are associated with content. The halftoning methods described herein provide advantages over alternative halftoning methods. For example alternative methods may include amplitude-modulation or frequency-modulation halftoning which are based on pre-computed threshold matrices of a fixed size that are designed to be tile-able. The present application describes methods that are less complex, less time consuming and less constrained in the halftone pattern properties. For example, the quasicrystal halftone patterns generated may be easily parallelized since threshold values are computed at a single pixel and as such the threshold values at each location do not depend on surrounding pixels or other threshold values. For example, in cases for large-format printers where massive parallelism is used it is desirable to use the information needed for consistent halftone patterns such as the (x,y) location on the page without the need to coordinate or synchronise or tile threshold matrices.

In another example, the methods disclosed herein may be consistently applied across various bit-depths in which the level of computation is the same and does not increase in its complexity with increasing bit-depth size.

The challenge of designing a halftone screen that is computed in situ (i.e. without a predetermined halftone threshold matrix) is fulfilled based on a global spatial location, a set of parameters and a predetermined analytical formula such as that of Eq. (1.1). The halftone screens designed are arbitrarily accurate in that the quasicrystal function Q operates on the continuous domain or real numbers, which in turn can be quantized into arbitrary integer precision. Likewise it can be thought of as having infinite size since no fixed-size threshold matrix needs to be computed but threshold values are computed at any location [x, y]. There are an infinite set of quasicrystal halftone screens that are possible which may be obtained by using quasicrystal functions with varying parameters. The parameters that may be varied may result in different patterns. The resulting patterns of the methods described herein allow for a wide range of halftone screens that vary in the level of overall pattern detail, or granularity at a given resolution. Some halftone screens generated may resemble those of amplitude-modulated halftone screens but without the strict regularity associated with amplitude-modulated halftone screens. This is advantageous, because the quasicrystal patterns have a greater robustness to periodic artifacts and yield a more visually pleasant halftone appearance. The quasicrystal halftone images have good robustness to dot placement errors too, in some cases similar to that of cluster-dot AM screen halftone masks known for this property. The quasicrystal halftone masks generated are suitable for line-drawings because the lack of a strict regularity is better at preserving the lines independent of angle, which may pose a significant challenge for traditional amplitude-modulated screening techniques. Traditional amplitude-modulated screens may suffer from an overly regular distribution which may not be visually pleasant and may aggravate periodic artifacts such as banding.

The halftoning methods described herein are achieved without the need for lengthy optimisations, the need to use explicit threshold matrices, or the need to resort to dithering or error diffusion techniques which would otherwise render parallelism difficult. There are memory savings from the ability to generate halftone patterns, masks or matrices in situ instead of existing methods which may require for the storage of a pre-computed threshold matrix. This can yield further benefits in the context of a Graphics Processing Unit (GPU) where limiting the amount of data to be shared among the processing cores is a mechanism to maximize performance, as is performing the same simple operations on large amounts of data—both applying well to the case of computing quasicrystal threshold values independently per-pixel.

While certain Figures are described herein, it is to be understood that the methods described herein may be performed without any explicit visualization.

At least some aspects of the examples described herein with reference to the drawings may be implemented using computer processes operating in processing systems or processors. These aspects may also be extended to computer programs, particularly computer programs on or in a carrier, adapted for putting the aspects into practice. The program may be in the form of non-transitory source code, object code, a code intermediate source and object code such as in partially compiled form, or in any other non-transitory form suitable for use in the implementation of processes described herein. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

In accordance with an embodiment of the present disclosure, there is provided a non-transitory computer-readable storage medium comprising a set of computer-readable instructions stored thereon, which, when executed by a processing system, cause the processing system to perform a method for generating a pattern of thresholds for halftone printing of an image, the method comprising using a quasicrystal function which relates the positions of pixels in the image to the halftone threshold value to be used.

In accordance with an embodiment of the present disclosure, there is also provided a printed article incorporating a halftone pattern generated using a quasicrystal function.

Similarly, it should be understood that a controller may in practice be provided by a single chip or integrated circuit or plural chips or integrated circuits, optionally provided as a chipset, an application-specific integrated circuit (ASIC), field-programmable gate array (FPGA), etc. For example, this may apply to all or part of a controller or other printer control circuitry. The chip or chips may comprise circuitry (as well as possibly firmware) for embodying at least a data processor or processors as described above, which are configurable so as to operate in accordance with the described examples. In this regard, the described examples may be implemented at least in part by computer software stored in (non-transitory) memory and executable by the processor, or by hardware, or by a combination of tangibly stored software and hardware (and tangibly stored firmware).

The preceding description has been presented only to illustrate and describe examples of the principles described. This description is not intended to be exhaustive or to limit these principles to any precise form disclosed. Many modifications and variations are possible in light of the above teaching.

What is claimed is:

1. A computer-implemented method of generating a pattern of thresholds for halftone printing of an image, the method comprising:
using a quasicrystal function which relates the positions of pixels in the image to the halftone threshold value to be used.

2. The method of claim 1, wherein the quasicrystal function comprises a superimposed series of periodic functions.

3. The method of claim 2, wherein the periodic functions are trigonometric or algebraic.

4. The method of claim 1, wherein a threshold value is computed at each single pixel of the image and independently of other pixels.

5. The method of claim 4, wherein each threshold value computed according to the quasicrystal function is transformed to a value in a set of values having a uniform distribution.

6. The method of claim 5, wherein the transformation further comprises:
referencing a transformation look-up-table; and
mapping each computed threshold value to transformed threshold values that have a uniform distribution of values.

7. The method of claim 5, wherein the said set of values having a uniform distribution is produced by calculating threshold values defined by the quasicrystal function at each pixel position in an area, and the calculated threshold values are transformed to a uniform distribution of values as the said look-up-table.

8. The method of claim 7, further comprising:
selecting the said area according to a chosen bit-depth of the threshold values;
calculating the threshold values for the pixel positions in the area according to the quasicrystal function;
computing quantiles and respective frequencies of the threshold values for the bit-depth of the halftone pattern;
assigning each quantile a respective bit-depth value; and
mapping the quantiles and respective frequencies of the threshold values to respective transformed threshold values.

9. The method of claim 8, further comprising a block of outputting a transformation look-up-table relating the threshold values calculated according to the quasicrystal function to the uniform threshold values.

10. The method of claim 1, wherein the halftone pattern is generated based on the quasicrystal function defined as:
Q_{n,t}(x,y)=Σᵢ cos(sin(θᵢ)x+cos(θᵢy+t))
wherein i is an integer value from 1 to n,
and θᵢ is a set of n parameters such that
$$θ = [ 0 , \frac{π}{n} , 2 \frac{π}{n} , … , . π ( 1 - \frac{1}{n} ) ]$$

11. The method of claim 1, further comprising a block of applying the halftone thresholds to image data, wherein the image data corresponds to an image to be printed, each threshold being calculated independently for each pixel position of the image.

12. A print processor for producing a quasicrystal print output comprising:
receiving image data indicative of an image to be printed;
using a quasicrystal function which relates the positions of pixels in the image to the halftone threshold value to be used at each pixel position of the image data; and
comparing each pixel value with the corresponding threshold.

13. A computer program which, when executed by a processing system, causes the processing system to generate a pattern of thresholds for halftone printing of an image using a quasicrystal function which relates the positions of pixels in the image to the halftone threshold value to be used.

14. The computer program of claim 13, wherein each threshold value computed according to the quasicrystal function is transformed to a value in a set of values having a uniform distribution, the transformation comprising:
referencing a transformation look-up-table; and
mapping each computed threshold value to a normalised threshold value that have a uniform distribution of values.

15. The computer program of claim 14, wherein the said set of values having a uniform distribution is produced by:
selecting an area according to a chosen bit-depth of the threshold values;
calculating the threshold values for the pixel positions in the area according to the quasicrystal function;
computing quantiles and respective frequencies of the threshold values for the bit-depth of the halftone mask;
assigning each quantile a respective bit-depth value; and
mapping the quantiles and respective frequencies of the threshold values to respective normalised threshold values.
